(19) United States
(12) Patent Application Publication
(10) Pub. No.: US 2023/0046612 A1
(43) Pub. Date: Feb. 16, 2023

(54) ION MOBILITY SPECTROMETRY-MASS SPECTROMETRY COMBINED ANALYSIS DEVICE

(71) Applicant: Shimadzu Corporation, Kyoto (JP)

(72) Inventors: Wenjian SUN, Shanghai (CN); Kuo-Feng TSENG, Shanghai (CN); Keke WANG, Shanghai (CN); Xiaoqiang ZHANG, Shanghai (CN)

(21) Appl. No.: 17/882,803

(22) Filed: Aug. 8, 2022

(30) Foreign Application Priority Data
Aug. 11, 2021 (CN) 202110921377.0

(51) Int. Cl. G01N 27/623; H01J 49/42

(52) U.S. Cl. CPC G01N 27/623; H01J 49/4215

(57) ABSTRACT

An ion mobility spectrometry-mass spectrometry combined analysis device includes an ionization source producing target analyte ions; an ion mobility filter receiving at least a part of the target analyte ions from the ionization source and operating in a sub-atmospheric environment to select ions within a specified mobility range from the target analyte ions to pass; and a mass filter connected to the rear stage of the ion mobility filter selecting ions in a specified mass-to-charge ratio range from the ions within the specified mobility range to pass. The ion mobility spectrometry-mass spectrometry combined device can separate the target ions based on a collision cross section under the combined action of a scanning electric field and an external gas flow, and operate at low gas pressure, which improves the efficiency of target analysis and an intra-spectrum dynamic range, and perform highly reliable and accurate quantitative analysis on specific target ions.

### CROSS-REFERENCE TO RELATED PATENT APPLICATION

This application claims priority to and the benefit of Chinese Patent Application Serial No. 202110921377.0, filed Aug. 11, 2021, which is incorporated herein in its entirety by reference.

### TECHNICAL FIELD

The present invention relates to the technical field of ion mobility analysis, and particularly relates to an ion mobility spectrometry-mass spectrometry combined analysis device.

### BACKGROUND ART

A mass spectrometer is an instrument that separates and detects the matter composition according to the mass difference of matter atoms, molecules or molecular fragments according to the principle that charged particles can be deflected in an electromagnetic field. It includes a quadrupole mass spectrometer, an ion trap mass spectrometer, a time-of-flight mass spectrometer, a magnetic mass spectrometer, etc. Among them, the quadrupole mass spectrometer is widely used in mass spectrometry quantitative analysis due to its high stability and high duty cycle in a fixed mass-to-charge ratio (m/z) channel. However, when target ions are isobaric elements or isomers, it is very difficult to distinguish them with a quadrupole mass analyzer with a lower mass resolution. One method to solve this problem is to use a triple quadrupole mass spectrometer to monitor mass-to-charge ratio channels of previous stage parent ions and latter stage fragment daughter ions simultaneously (commonly referred to as multi reaction monitoring, an MRM mode), and this method is very useful in most cases, however, the above strategy will not work if the previous stage ions and the fragment ions happen to have the same mass-to-charge ratio. To further differentiate two target molecules, other methods are required.

Ion mobility spectrometers can distinguish ions based on collision cross sections that are relatively independent of molecular weight. Considering two target molecules with the same mass-to-charge ratio but with different collision cross sections, if the ion beam passes through an ion mobility analyzer first and then enters a quadrupole mass analyzer, then the two matters can be distinguished. However, typical ion mobility spectrometers operate in a drift mode (Drift tube ion mobility spectrometry, DTIMS for short, and Travelling wave ion mobility spectrometry, TW-IMS for short) or in a scan mode (Trapped ion mobility spectrometry, TIMS for short) (Karasek et. al., Anal. Chem. 48, 1133-1137 (1976); US. Pat. Nos. 9,939,408B2; 9,741,552B2), therefore, quadrupole mass spectrometers can only analyze targets when their migration peaks appear, which only occupies a very small part of the overall analysis process. As for the quadrupole mass analyzer, it possesses a very low duty cycle, which is not conducive to a stable analysis process. Therefore, it is necessary to combine a filter type mobility analyzer with the quadrupole mass analyzer for better quantitative analysis. At the same time, a collision cross section channel of the mobility analyzer and a mass-to-charge ratio channel of the quadrupole mass analyzer correspond to each other, which can reduce chemical noise and improve quantitative accuracy.

A differential mobility analyzer (DMA for short), a differential mobility spectrometry (DMS for short), and a high field asymmetric ion mobility spectrometry (FAIMS for short) are all filter type ion mobility spectrometry devices. They have been used in combination with the quadrupole mass analyzer in the past (for example, US. Pat. No. 7,855,360 B2). However, DMA equipment is mainly used for analytical aerosol analysis; for techniques targeting small molecules, the resolution is generally very low (around 50) (Rus et. al., Intl. J. Mass. Spec. 298, 30-40 (2010)). DMS (or FAIMS) is a method that utilizes the different clustering effects between different analytes and solvent molecules when ions are subjected to alternating high and low voltage electric fields for separation, and for commercial products, its resolution is also very low (less than 20) (US. Pat. No. 9,846,143B2: Dodds, et. al., Anal. Chem. 89, 12176-12184 (2017)), and the method that utilizes the clustering effect of the analyte and the solvent molecules to separate ions is highly dependent on the chemical property and environment of the analyte, thereby making prediction difficult to obtain. In addition, both DMA and DMS products typically operate at an atmospheric pressure and suffer from very high ion losses when combined with mass spectrometers. Therefore, there is an urgent need for an ion mobility spectrometry-mass spectrometry combined device with a high resolution, low ion loss, and very high predictable separation characteristic to perform highly reliable and accurate quantitative analysis for specific target ions.

### SUMMARY OF THE INVENTION

In view of the above problems, the present invention provides an ion mobility spectrometry-mass spectrometry combined analysis device, which can separate target ions based on a collision cross section under the combined action of a scanning electric field and an external gas flow, and can operate under a low gas pressure to improve the efficiency of target analysis and an intra-spectrum dynamic range, and can perform highly reliable and accurate quantitative analysis on specific target ions.

In order to achieve the above objects and other related objects, the ion mobility spectrometry-mass spectrometry combined analysis device provided by the present invention includes: an ionization source producing target analyte ions; an ion mobility filter receiving at least a part of the target analyte ions from the ionization source, the ion mobility filter operating in a sub-atmospheric environment to select ions within a specified mobility range from the target analyte ions to pass; and a mass filter connected to the rear stage of the ion mobility filter, and selecting ions in a specified mass-to-charge ratio range from the ions within the specified mobility range to pass.

In a preferred technical solution of the present invention, the ion mobility filter is a low vacuum differential mobility analyzer.

In a preferred technical solution of the present invention, the ion mobility filter is a U-shaped ion mobility analyzer (UMA for short, Wang et. al., Anal. Chem. 92, 8356-8363 (2020); U.S. Pat. No. 10739308B2; CN109003876B).

In a preferred technical solution of the present invention, the operating gas pressure of the U-shaped ion mobility analyzer is 50-300 Pa.

In a preferred technical solution of the present invention, the mass filter is a quadrupole mass filter, a magnetic deflection mass filter or a double-focusing mass filter.

In a preferred technical solution of the present invention, the ion mobility spectrometry-mass spectrometry combined analysis device further comprises a mass analyzer connected to the rear stage of the mass filter, and the mass analyzer is a quadrupole mass analyzer, a magnetic deflection mass analyzer, a double-focusing mass analyzer, a time-of-flight mass spectrometry, an ion trap mass spectrometry, an orbitrap mass spectrometry or a Fourier transform ion cyclotron resonance mass spectrometry.

In a preferred technical solution of the present invention, a first ion dissociation device is arranged between the ion mobility filter and the mass filter, and the first ion dissociation device is a collision induced dissociation device, a surface induced dissociation device, a light induced dissociation device or an electron capture dissociation device.

In a preferred technical solution of the present invention, a second ion dissociation device is arranged between the mass filter and the mass analyzer, and the second ion dissociation device is a collision-induced dissociation device, a surface-induced dissociation device, a light-induced dissociation device, or an electron capture dissociation device.

The present invention further provides an ion mobility spectrometry-mass spectrometry combined analysis method, comprising the following steps:

producing target analyte ions;

receiving at least a part of the target analyte ions, and selecting ions within a specified mobility range from the target analyte ions to pass by an ion mobility filter operating in a sub-atmospheric environment; and

using a mass filter connected to the rear stage of the ion mobility filter to select ions in a specified mass-to-charge ratio range from the ions within the specified mobility range to pass.

Switching among a plurality of discontinuous ion mobility channels to select one ion mobility channel as the specified mobility range, wherein each ion mobility channel corresponds to one or more mass-to-charge ratio channels of the mass filter.

In the step of switching among the plurality of discontinuous ion mobility channels to select one ion mobility channel, switching the ion mobility channel and the mass-to-charge ratio channel simultaneously at specified time to change target analytes.

Providing a mass analyzer connected to the rear stage of the mass filter, and a combination of one ion mobility channel and one mass-to-charge ratio channel of the mass filter corresponds to one or more mass-to-charge ratio channels of the mass analyzer.

Beneficial Effects: The ion mobility spectrometry-mass spectrometry combined analysis device is small in transmission cross section loss and with high resolution, so that ions can be better separated, thereby reducing ions loss. In addition, the ion mobility spectrometry-mass spectrometry combined analysis device can also improve the analysis efficiency of the target analyte and the intra-spectrum dynamic range, thereby obtaining better quantitative results.

### BRIEF DESCRIPTION OF THE DRAWINGS

FIG. 1 is a schematic diagram of an ion mobility filter used in combination with a single quadrupole mass spectrometer in Example 1 of the present invention;

FIG. 2 is an ion mobility spectrogram of two phosphazine derivative ions in a 10% Agilent tuning mixed liquid in Example 1 of the present invention;

FIG. 3 is an ion mobility spectrogram of two phosphazine derivative ions after reserpine is added to the 10% Agilent tuning mixed liquid in Example 1 of the present invention;

FIG. 4 is a schematic diagram of an ion mobility filter used in combination with a triple quadrupole mass spectrometer in Example 2 of the present invention;

FIG. 5 is an ion mobility spectrogram of Tetraethyl Michler's Ketone when a first mass-to-charge ratio channel fixed to a 325 mass channel in Example 2 of the present invention;

FIG. 6 is an ion mobility spectrogram of two mass channels in an MRM mode in Example 2 of the present invention;

FIG. 7 is a second order mass spectrum of an N-Protomer in Example 2 of the present invention;

FIG. 8 is a second order mass spectrum of an O-Protomer in Example 2 of the present invention; and

FIG. 9 is a mode of various ion mobility filters used in combination with a mass spectrometry in Example 3 of the present invention.

Reference numerals: 1-ionization source; 2-capillary tube; 3-first ion guiding device; 4-second ion guiding device; 5-third ion guiding device; 6-first ion dissociation device; 7-second ion dissociation device; 80-first mass-to-charge ratio channel; 81-second mass-to-charge ratio channel; 9-ion mobility filter; 10-mass analyzer; 11-pump; 12-gas.

### DETAILED DESCRIPTION OF THE INVENTION

The technical solutions in the embodiments of the present invention will be clearly and completely described below with reference to the accompanying drawings in the embodiments of the present invention. Obviously, the described embodiments are only a part of the embodiments of the present invention, not all of the embodiments. Based on the embodiments in the present invention, all other embodiments obtained by those of ordinary skill in the art without creative work fall within the protection scope of the present invention

The present invention provides an ion mobility spectrometry-mass spectrometry combined analysis device, wherein an ion mobility spectrometry device is an ion mobility filter 9 being capable of screening target analytes based on an ion collision cross section and having a very high duty cycle. The ion mobility filter 9 may include, but is not limited to, a differential mobility analyzer (DMA) operating under low vacuum, a differential mobility spectroscopy (DMS) or asymmetric high field mobility spectroscopy (FAIMS) operating under low vacuum, preferably, the ion mobility filter 9 is a U-shaped ion mobility analyzer (UMA). Amass spectrometry device is a mass filter such as a quadrupole or magnetic mass spectrometer, such a mass spectrometry device with a mass filtering function can be linked with the ion mobility filter 9 to perform highly reliable and accurate quantitative analysis on specific target ions.

It should be noted that the term “low vacuum” in the present invention refers to a vacuum environment of 10-3000 Pa.

In addition, in some embodiments of the present invention, the ion mobility filter may be a device for screening ions based on the ion collision cross section. However, those skilled in the art can understand that the ion collision cross section has physical equivalence or correlation with parameters such as an ion mobility and an ion collision volume, and in some embodiments of the present invention, the ion mobility filter can also be based on any one or a combination of the ion collision cross section, the ion collision volume, and the ion mobility, to screen ions.

### Example 1

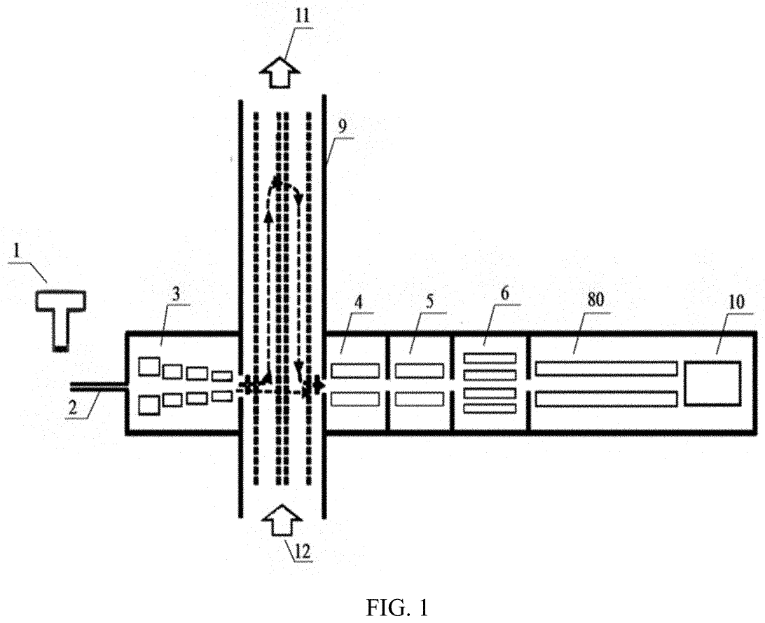

FIG. 1 is a schematic diagram of an ion mobility filter 9 used in combination with a single quadrupole mass spectrometer in Example 1 of the present invention. As shown in FIG. 1, an ion mobility spectrometry-mass spectrometry combined analysis device in this example comprises an ionization source 1 producing target analyte ions; an ion mobility filter 9 receiving at least a part of the target analyte ions from the ionization source 1, the ion mobility filter 9 operating in a sub-atmospheric environment to select ions within a specified mobility range from the target analyte ions to pass; and a mass filter connected to the rear stage of the ion mobility filter 9, and selecting ions in a specified mass-to-charge ratio range from the ions within the specified mobility range to pass.

In addition, the ion mobility spectrometry-mass spectrometry combined analysis device in this example further comprises a capillary tube 2, a first ion guiding device 3, a second ion guiding device 4, a third ion guiding device 5, a first ion dissociation device 6, and a mass analyzer 10.

Specifically speaking, the ion mobility filter 9 in this example is a U-shaped ion mobility analyzer, and the mass filter is a first mass-to-charge ratio channel 80. The target analyte ions are produced by the ionization source 1, enter the first ion guiding device 3 having a vacuum degree of about 200 Pa through the capillary tube 2, and then enter the U-shaped ion mobility analyzer, a voltage is applied to the U-shaped ion mobility analyzer to form an electric field, and a gas 12 flows in from one end of the U-shaped ion mobility analyzer, and the gas is pumped away at the other end by a pump 11, thereby adding a gas flow in a direction perpendicular to an ion introduction direction. Under the combined action of a scanning electric field and the external gas flow, the U-shaped ion mobility analyzer establishes a pair of ion channels and allows ions of a specific collision cross section to pass, wherein the degree of vacuum is between 50 Pa and 300 Pa, preferably 150-200 Pa; screened ions successively pass through the second ion guiding device 4 with a degree of vacuum of about 10 Pa and the third ion guiding device 5 with a degree of vacuum of about 0.1 Pa, then enter the first ion dissociation device 6 for dissociation and fragmentation, then enter the subsequent first mass-to-charge ratio channel 80 for a second-step selection, and finally enter the mass analyzer 10 for detection and analysis.

It should be particularly noted that the U-shaped mobility analyzer in this example is in a gas pressure range of 50-300Pa, preferably 150-200 Pa, the ions can not only be separated well, but also can be bound by a radio frequency voltage, thereby reducing an ion loss. Although a differential mobility spectrometry analyzer can also screen ions of a certain collision cross section, it usually only operates under an atmospheric pressure, so a transmission cross section loss is very large, and the resolution is very low at the same time. If the differential mobility spectrometry analyzer can be put into operation under a low gas pressure, requirements of the present invention can also be partially satisfied.

In a conventional mass spectrometry analysis process, a method usually used for analysis of isomers or paramorphs is to use a tandem mass spectrometer to dissociate ions to be tested, and to distinguish types of parent ions by a difference in the mass of daughter ions. This method is limited to that when the isomers and the paramorphs have very similar structures, most of their daughter ions are of the same mass, and it will be very difficult to distinguish them with a tandem mass spectrometry at this time. The introduction of the ion mobility filter 9 can distinguish the ions from another dimension: different mobilities represent ions with different collision cross sections, and isomers or paramorphs of the same mass can be separated on a mobility axis. At the same time, since the ion mobility analyzer and the mass analyzer 10 used in this example are both in filter types, no matter in any channel during the scanning process, ions belonging to other channels will be removed in real time, and will not produce an influence such as a space-charge effect on ions in a current channel. In this mode of operation, a very good intra-spectrum dynamic range can be obtained in an analysis process of the target analyte ions. For a non-filter type mobility spectrometry, such as a drift tube ion mobility spectrometry, a travelling wave mobility spectrometry, and a trapped ion mobility spectrometry, all target ions need to be accumulated in one place in advance, and then are analyzed one by one. For compounds with very different concentration ratios in a mixture, low-concentration samples will easily be greatly reduced in sensitivity due to the effect of space charges, which will greatly affect the intra-spectrum dynamic range. Of course, in order to obtain a better intra-spectrum dynamic range, the mass spectrometry is also preferably a filter type analyzer, which is also the reason why a quadrupole mass analyzer is selected for use in this example. At the same time, the magnetic mass spectrometer or double focusing mass spectrometer is also a filter type analyzer, which can also meet the requirements of the present invention.

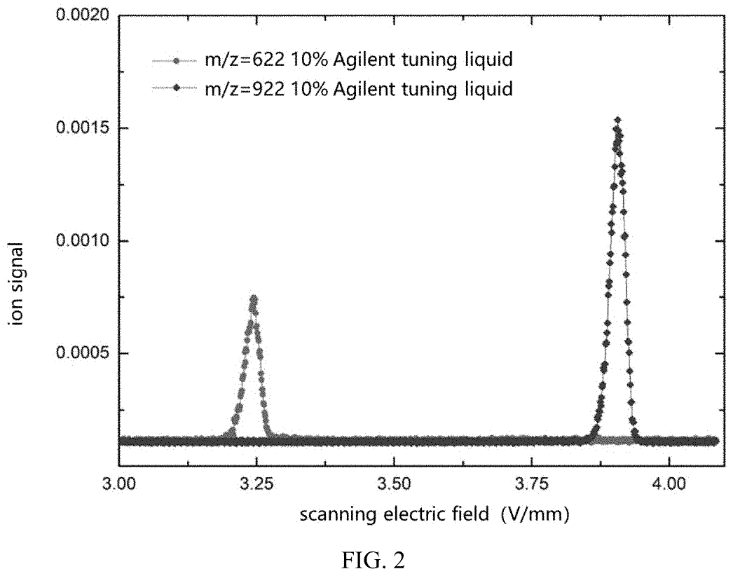

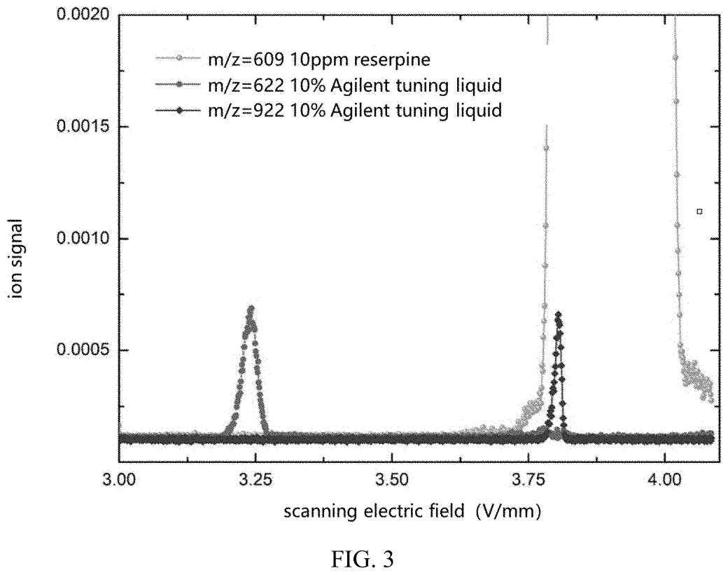

FIG. 2 is an ion mobility spectrogram for measuring two phosphazine derivative ions in a 10% Agilent tuning mixed liquid in Example 1 of the present invention. The first step designed in the experimental is to use the ions of two phosphazine derivatives in the 10% Agilent tuning mixed liquid, whose mass-to-charge ratios (m/z) are 622 and 922, respectively, to carry out analysis by combining an ion filtration mode of the U-shaped ion mobility analyzer and a quadrupole mass spectrometer. The concentrations of both target analytes are approximately 1 ppb. As shown in FIG. 2, when the quadrupole mass filter is fixed at mass channels with the m/z of 622 and 922, ion peaks can respectively appear at 3.24 V/mm and 3.90 V/mm during electric field scanning of the U-shaped ion mobility analyzer. Here different peak appearing positions represent different ion collision cross sections. In the second step, 10 ppm of reserpine (m/z 609) is added to the 10% Agilent tuning mixed liquid. FIG. 3 is an ion mobility spectrogram of two phosphazine derivative ions after reserpine is added to the 10% Agilent tuning mixed liquid in Example 1 of the present invention. As shown in FIG. 3, the experiment shows that even if a reserpine (m/z 609) solution with a relatively high concentration is added, the ion mobility peak of the phosphazine derivative with the m/z of 922 can still appear, its ion appearing peak position and intensity are only slightly affected by the reserpine solution of the high concentration. In contrast, in an ion mobility analysis mode, which requires prior accumulation and then perform release one by one, a result obtained for the same analyte is that a peak of a low-concentration sample with the m/z of 922 completely disappears due to the space-charge effect. The above results can illustrate advantages of using the ion mobility filter 9 for wide dynamic range analysis within a spectrum.

### Example 2

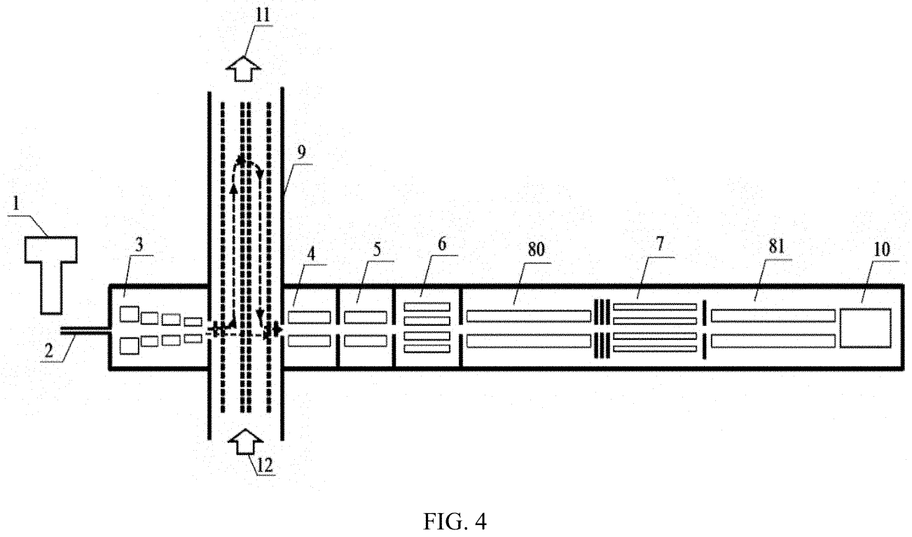

For the analysis device described in Example 1, sometimes there is interference from chemical noise, namely, channels with a particular mobility and mass-to-charge ratio may also contain other chemical background substances, such as solvents or impurities. Quantitative data obtained at this time may not be accurate enough, and a tandem mass spectrometry is required to further remove the interference from chemical noise. FIG. 4 is a schematic diagram of an ion mobility filter 9 used in combination with a triple quadrupole mass spectrometer in Example 2 of the present invention. As shown in FIG. 4, the ion mobility spectrometry-mass spectrometry combined analysis device includes: an ionization source 1, a capillary tube 2, a first ion guiding device 3, an ion mobility filter 9, a second ion guiding device 4, a third ion guiding device 5, a first ion dissociation device 6, a first mass-to-charge ratio channel 80, a second ion dissociation device 7, a second mass-to-charge ratio channel 81, and a mass analyzer 10.

In this example, the ion mobility filter 9 is still a U-shaped ion mobility analyzer, and a mass filter includes the first mass-to-charge ratio channel 80 and the second mass-to-charge ratio channel 81. Specifically, the U-shaped ion mobility analyzer is used in conjunction with the triple quadrupole mass spectrometer, parent ions selected by the U-shaped ion mobility analyzer and the first mass-to-charge ratio channel 80 will be dissociated through the second ion dissociation device 7, and daughter ions then are screened by the second mass-to-charge ratio channel 81, and finally enter the mass analyzer 10 for detection and analysis. Quantitative data obtained from mass screening twice are more accurate due to exclusion of the interference of the chemical noise.

In this example, the first ion dissociation device 6 and the second ion dissociation device 7 can be a collision induced dissociation device, a light induced dissociation device or an electron capture dissociation device or the like. The first ion dissociation device 6 and the second ion dissociation device 7 may be subsequently connected to a filter type mass spectrometer such as a quadrupole mass spectrometer, a magnetic mass spectrometer or the like, or a scanning-type mass spectrometer such as a time-of-flight mass spectrometer, an electrostatic trap mass spectrometer, a Fourier transform ion cyclotron resonance mass spectrometer or the like.

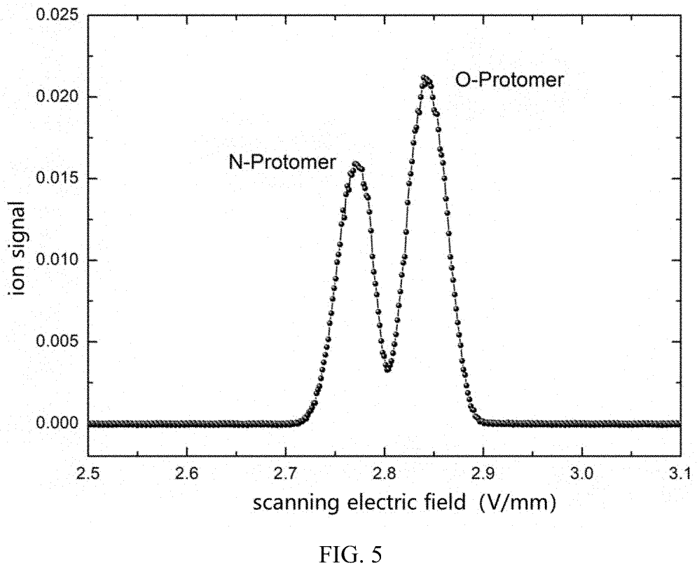

FIG. 5 is an ion mobility spectrogram of Tetraethyl Michler's Ketone (chemical structural formula I) when a first mass-to-charge ratio channel is fixed to a 325 mass channel in Example 2 of the present invention.

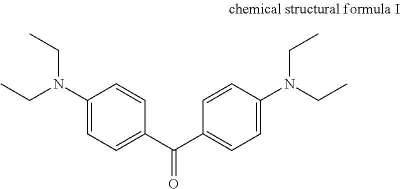 [SMILES: CCN(CC)c1ccc(C(=O)c2ccc(N(CC)CC)cc2)cc1]

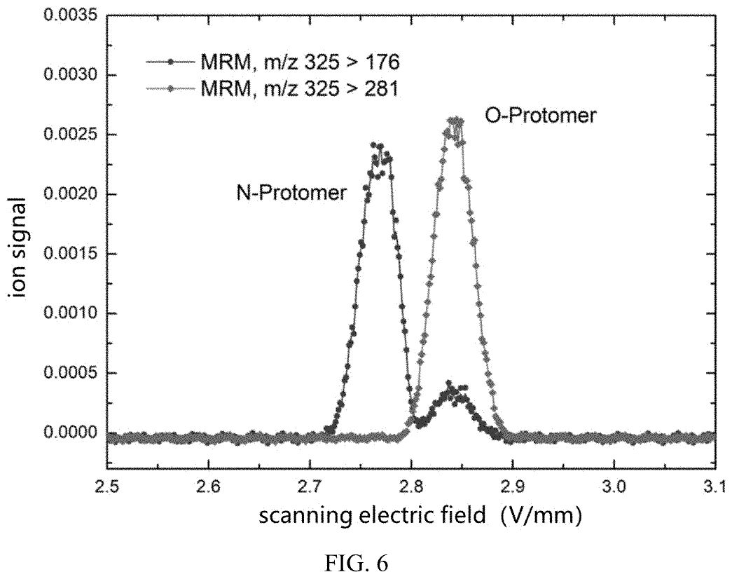

FIG. 6 is an ion mobility spectrogram of two mass channels in an MRM mode in Example 2 of the present invention.

Specifically, in Example 2, an experimental example is used to illustrate the advantages of using the ion mobility filter 9 in combination with the triple quadrupole mass spectrometer, and in this example, Tetraethyl Michler's Ketone (the mass to charge ratio being 325) is used for performing separation and calibration of protonated isomers.

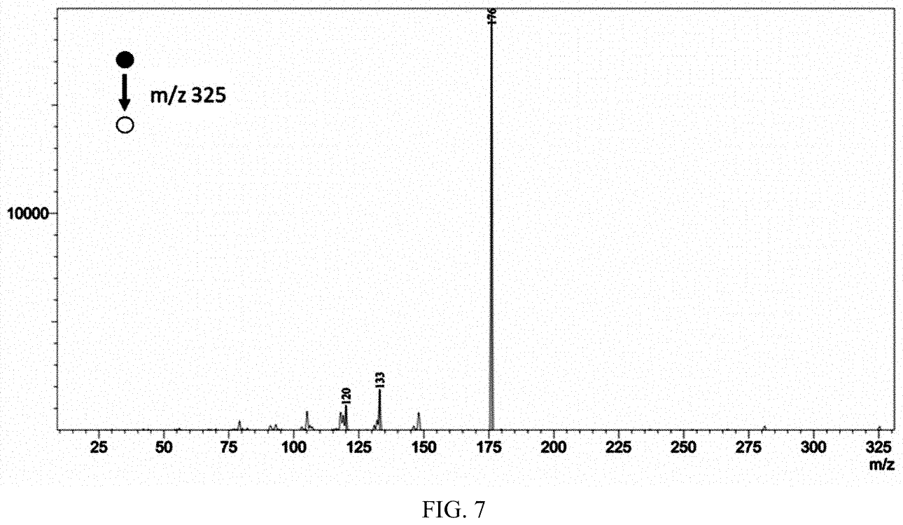

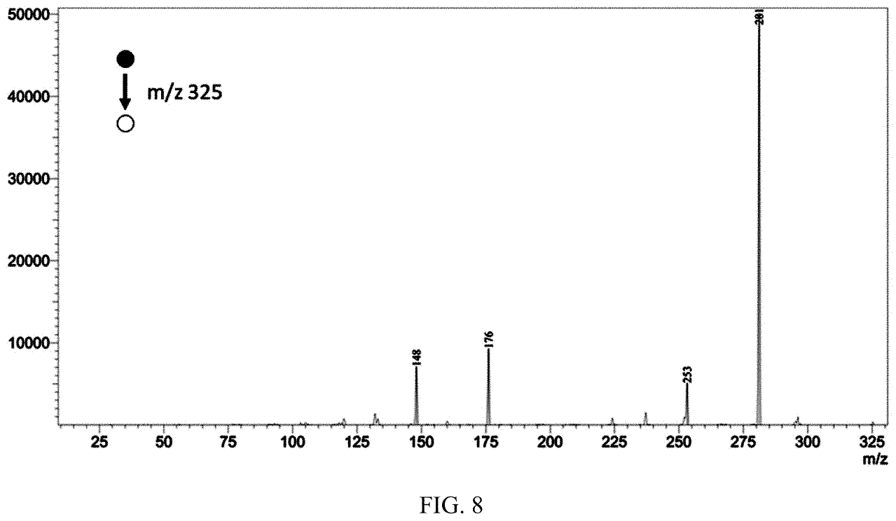

FIG. 5 is the ion mobility spectrogram of Tetraethyl Michler's Ketone when the first mass-to-charge ratio channel 80 is fixed to the mass channel with the m/z of 325. The U-shaped ion mobility analyzer shows two ion peaks when an electric field is scanned to near 2.8 V/mm. This result indicates that Tetraethyl Michler's Ketone has two different protonation sites, and a difference of the protonation sites will bring about a difference of its spatial configuration (i. e. a difference of peak appearing positions of a mobility spectrometry). According to the literature, it is speculated that a mobility spectrometry peak which appears first is an N-Protomer and protons are attached to a tertiary amine group; and a mobility spectrometry peak which appears latter is an O-Protomer, and protons act on a carbonyl group. To further analyze the isomers, multiple reaction monitoring (MRM mode) is performed using the triple quadrupole mass spectrometer. FIG. 6 shows the ion mobility spectrogram of two mass channels with m/z 325>176 and m/z 325>281, respectively, in the MRM mode, and the result shows that different protonation sites also have an effect on the dissociation mode of the ions. For the N-Protomer, there is only one dissociation channel with m/z 325>176. FIG. 7 is a second order mass spectrum of the N-Protomer in Example 2 of the present invention; but for the O-Protomer, there are two dissociation channels with m/z 325>176 and m/z 325>281. FIG. 8 is a second order mass spectrum of an O-Protomer in Example 2 of the present invention.

The above analysis experiment examples fully demonstrate that qualitative or quantitative analysis on isomer ions may be incomplete and inaccurate whether using a combination of the ion mobility spectrometry and a single quadrupole mass analyzer alone or using triple quadrupole mass spectrometer MRM mode alone. The ion mobility filter 9 and the tandem mass spectrometer combined analysis method proposed in this example can further confirm the identity of the ions and perform quantitative analysis.

### Example 3

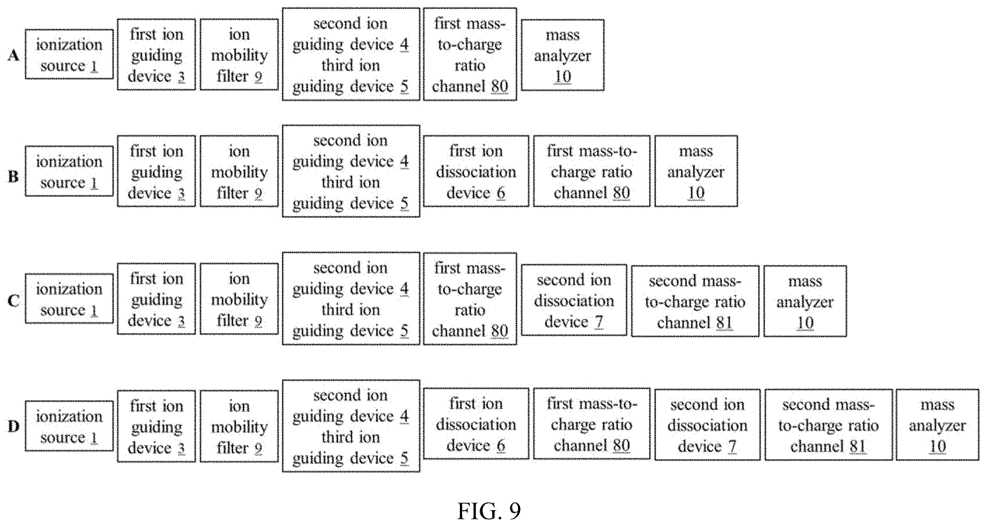

In actual analysis, sometimes an ion mobility filter 9 can separate some of the isomers, but the resolution is still limited. Other impurities, such as clustered solvent ions or other non-target ions with a similar mobility and mass-to-charge ratio, may also be included in the same mobility channel. By screening daughter ions of each isomer directly after mobility selection, interference from solvent clusters or other impurities can be effectively reduced, which increases the accuracy of the overall quantification process. FIG. 9 is modes of various ion mobility filters 9 used in combination with a mass spectrometry in Example 3 of the present invention, which are divided into four modes: A, B, C and D, wherein the B mode reflects instrument configuration required by the above-mentioned modes, namely, a first ion dissociation device 6 is additionally mounted at the rear end of the ion mobility filter 9, and the function thereof is to directly dissociate and break ions sorted out from the ion mobility filter 9, and then perform second-step selection and detection by a subsequent mass filter.

The structure shown in the B mode in FIG. 9 can be further expanded to become a structure shown in the D mode in FIG. 9 in combination with the combination of the ion mobility filter 9 and the triple quadrupole mass analyzer described in Example 2, i. e., the ions selected by the ion mobility filter 9 pass through the first ion dissociation device 6 to obtain first-order daughter ions, and are screened by the first mass-to-charge ratio channel 80, the screened ions then enter the second ion dissociation device 7 to obtain second-order daughter ions, and are screened by the second mass-to-charge ratio channel 81, and ions which finally pass enter a mass analyzer 10 for detection. This process has the advantages that when a very complex mixture is analyzed, more accurate screening can be performed according to multiple information, such as different mobilities and parent/daughter ion masses of the compounds, further reducing the probability of false positives.

The A mode in FIG. 9 and the C mode in FIG. 9 correspond to instrument settings of Example 1 and Example 2 of the present invention, respectively, and will not be described again here.

The above-described examples merely illustratively describe the principles of the invention and its efficacy, and are not intended to limit the present invention. All those skilled in the art can modify or change the examples described above without departing from the spirit and scope of the present invention. Therefore, all equivalent modifications or changes made by those with ordinary knowledge in the technical field without departing from the spirit and technical idea disclosed in the present invention shall still be covered by the claims of the present invention.

What is claimed is:

1. An ion mobility spectrometry-mass spectrometry combined analysis device, comprising:
an ionization source producing target analyte ions;
an ion mobility filter receiving at least a part of the target analyte ions from the ionization source, the ion mobility filter operating in a sub-atmospheric environment to select ions within a specified mobility range from the target analyte ions to pass; and
a mass filter connected to the rear stage of the ion mobility filter, and selecting ions in a specified mass-to-charge ratio range from the ions within the specified mobility range to pass.

2. The ion mobility spectrometry-mass spectrometry combined analysis device according to claim 1, wherein the ion mobility filter is a low vacuum differential mobility analyzer.

3. The ion mobility spectrometry-mass spectrometry combined analysis device according to claim 1, wherein the ion mobility filter is a U-shaped ion mobility analyzer.

4. The ion mobility spectrometry-mass spectrometry combined analysis device according to claim 3, wherein the operating gas pressure of the U-shaped ion mobility analyzer is 50-300 Pa.

5. The ion mobility spectrometry-mass spectrometry combined analysis device according to claim 1, wherein the mass filter is a quadrupole mass filter, a magnetic deflection mass filter or a double-focusing mass filter.

6. The ion mobility spectrometry-mass spectrometry combined analysis device according to claim 1, further comprising a mass analyzer connected to the rear stage of the mass filter, and the mass analyzer is a quadrupole mass analyzer, a magnetic deflection mass analyzer, a double-focusing mass analyzer, a time-of-flight mass spectrometry, an ion trap mass spectrometry, an orbitrap mass spectrometry or a Fourier transform ion cyclotron resonance mass spectrometry.

7. The ion mobility spectrometry-mass spectrometry combined analysis device according to claim 1, wherein a first ion dissociation device is arranged between the ion mobility filter and the mass filter, and the first ion dissociation device is a collision induced dissociation device, a surface induced dissociation device, a light induced dissociation device or an electron capture dissociation device.

8. The ion mobility spectrometry-mass spectrometry combined analysis device according to claim 5, wherein a second ion dissociation device is arranged between the mass filter and the mass analyzer, and the second ion dissociation device is a collision-induced dissociation device, a surface-induced dissociation device, a light-induced dissociation device, or an electron capture dissociation device.

9. An ion mobility spectrometry-mass spectrometry combined analysis method, comprising the following steps:
producing target analyte ions;
receiving at least a part of the target analyte ions, and selecting ions within a specified mobility range from the target analyte ions to pass by an ion mobility filter operating in a sub-atmospheric environment; and
using a mass filter connected to the rear stage of the ion mobility filter to select ions in a specified mass-to-charge ratio range from the ions within the specified mobility range to pass.

10. The ion mobility spectrometry-mass spectrometry combined analysis method according to claim 9, further comprising the following steps:
switching among a plurality of discontinuous ion mobility channels to select one ion mobility channel as the specified mobility range, wherein each of the ion mobility channels corresponds to one or more mass-to-charge ratio channels of the mass filter.

11. The ion mobility spectrometry-mass spectrometry combined analysis method according to claim 10, wherein in the step of switching among the plurality of discontinuous ion mobility channels to select one ion mobility channel, switching the ion mobility channel and the mass-to-charge ratio channel simultaneously at specified time to change target analyte.

12. The ion mobility spectrometry-mass spectrometry combined analysis method according to claim 10, further comprising the following steps:
providing a mass analyzer connected to the rear stage of the mass filter, and a combination of one of the ion mobility channels and one of the mass-to-charge ratio channels of the mass filter corresponds to one or more mass-to-charge ratio channels of the mass analyzer.

13. The ion mobility spectrometry-mass spectrometry combined analysis method according to claim 9, wherein the ion mobility filter is a U-shaped ion mobility analyzer operating in an environment of 150-200 Pa.
